(19) United States
(12) Patent Application Publication
(10) Pub. No.: US 2006/0122780 A1
(43) Pub. Date: Jun. 8, 2006

(54) Method and apparatus for seismic feature extraction

(75) Inventors: Israel Cohen, Haifa, IL (US); Anthony Vassiliou, Houston, TX (US); Nicholas Coult, Minneapolis, MN (US)

Correspondence Address: LAW OFFICE OF MICHAEL R. NICHOLS, 3001 S. HARDIN BLVD. STE. 110, PMB #155, MCKINNEY, TX, 75070, US

(73) Assignee: GeoEnergy, Inc, Houston, TX (US)

(21) Appl. No.: 10/534,149

(22) PCT Filed: Nov. 10, 2003
(86) PCT No.: PCT/US03/36219

§ 371 Date: Nov. 14, 2005

(30) Foreign Application Priority Data
Nov. 9, 2002 (US) 60424937

(51) Int. Cl. G01V 1/00; G01V 1/28

(52) U.S. Cl. 702/14

(57) ABSTRACT

A method and apparatus for seismic image processing is disclosed. A preferred embodiment aids in the identification of subterranean faults, which are significant in hydrocarbon exploration. The method includes steps of: a) reading a three dimensional seismic data volume; b) computing the three-dimensional orientation of the subsurface; c) subdividing the original volume into small data volumes that are rotated at a predetermined set of dips and azimuths related to those of the subsurface orientation; volumes formed in step c; e) performing a 3-D contrast enhancement operation in each of the small volumes; f) filtering the result of the contrast enhancement with selected 3-D filters at the predetermined set of dips and azimuths; g) skeletonizing the results of the filtering operation; h) separating the individual fault surfaces, and i) labelling the individual fault surfaces for further interpretation and exploration.

### TECHNICAL FIELD

The present invention relates generally to improvements in the field of seismography. In particular, the present invention provides a method and apparatus for processing seismic image data to more clearly reveal geologic features such as faults.

### BACKGROUND ART

Almost all geophysical exploration, and in particular hydrocardon exploration, includes the use of seismic methods. Seismic exploration generally begins with a seismic data acquisition in an area that has been identified as promising for hydrocarbon exploration. Seismic data acquisition surveys use acoustic sources (generally referred to as “shots”) as a source of seimic waves. Those seismic waves propagate radially through the ground in accordance with the acoustic impedance (analogous to electrical impedance in electric circuit theory) of the geologic layer(s) through which the waves travel. For example, in, point S represents the location of such an acoustic source with respect to a vertical cross-section of ground showing two geologic layers or “strata” 100 and 102. Line 104 represents the direction of travel for a point on the radiating seismic wavefront generated by the source at S. Point R lies on the interface between two geologic layers having different acoustic impedances. According to basic principles of physics, when a wavefront comes into contact with the interface between two media of different impedances (i.e., an impedance “mismatch”), at least a portion of the wave energy is reflected back from the interface in the general direction of the source. Generally speaking, a portion of the wave energy will also be transmitted across the interface, although the direction of the transmitted wavefront may change. This change in direction is known as diffraction. Well-understood physical laws, such as Snell's law, govern the velocity and direction of these reflected and refracted waves. Thus, because the velocity and direction of incident and reflected or refracted waves can be determined mathematically, it is possible to identify the locations of acoustic impedance mismatches by measuring the amount of time it takes for a reflected/refracted wave to reach an observation point on the surface.

For example, in, an incident wavefront travelling in the direction of line 104 will reach the interface between layer 100 and layer 102 at point R, at which point the impedance mismatch between layer 100 and layer 102 causes a reflection of the wave to travel in the direction of line 106 to point D (the detection point) where the arrival time of the reflected wave can be measured. Since the velocity and direction of travel of the incident and reflected wave can be determined mathematically, the depth of point R, as measured from the surface can be determined from the arrival time of the reflected wave. This process is known as reflection seismography, and it provides information about the locations, shapes, and material compositions of various geologic features. Knowledge of these features may be used for locating hydrocarbons or other mineral resources, as well as for other uses, such as determining the geologic structure of a particular site for civil engineering purposes, for example. Another application for this general type of technology is in the medical field, where ultrasonic acoustic waves are used in a similar fashion to perform medical imaging (e.g., sonograms).

Returning now to the problem of geophysical exploration, however, it is customary to employ multiple seismic detectors at different points will be used in conjunction with a single acoustic source, to allow seismic data to be obtained over a broad area. Different types of acoustic sources are used in different arrangements, depending on the environment in question. Typically in onshore areas, “Vibroseis” acoustic sources are used to transmit seismic waves on the subsurface, which are transmitted and reflected off several subterranean layers, and eventually a portion of the originally transmitted energy is reflected back towards the earth's surface and received at detectors (receivers), which are spaced at predetermined spatial positions as to minimize the acquisition cost and increase the seismic data acquisition survey resolution. (Vibroseis was formerly a registered trademark of Conoco, Inc., but is now recognized as a generic term in the art). For offshore areas, the seismic vessel performing the seismic data acquisition uses airguns or waterguns which generate a significant pressure wave which propagates in the subsurface. The reflected seismic energy travelling back from the subsurface towards the ocean bottom is either received at receiver streamer cables towed by the seismic vessel or by ocean-bottom receivers placed by oil and gas companies.

Seismic survey data can also be categorized by the dimensionality of the data. “Two-dimensional” seismic data is obtained by placing the detectors in a single line. The information obtained in a two-dimensional survey provides the same type of visual perspective as, where the two dimensions are linear position along the line of detectors (horizontal) and depth (vertical, plotted downward). One of ordinary skill in the art will recognize that the depth coordinate is interchangeable with time, since the arrival time of a reflected wave determines the depth of the reflector. Mathematically speaking, two-dimensional seismic data is represented as two dimensional scalar field, where the scalar value represents a magnitude of the seismic signal received at a particular surface position at a particular time.

“Three-dimensional” seismic data is obtained by arranging the detectors over a two-dimensional area on the surface. Usually, the detectors are arranged in some form of grid. A set of three-dimensional seismic data is a three-dimensional scalar field that represents a magnitude of the seismic signal received at a particular surface position at a particular time. During seismic data acquisition, the data are typically recorded in digital media, and their sheer volume, particularly in the case of a three-dimensional survey, can easily exceed several terabytes (1×10¹² bytes).

After the raw seismic data is obtained, it is then processed to extract useful information, typically in a graphic format. A variety of seismic data processing algorithms have been developed over the years. These algorithms take into account the seismic source and receiver positions, estimate the acoustic/elastic constants of the subsurface, and finally “migrate” the data, meaning that they identify the proper locations of the subsurface reflectors (i.e., the geologic features that cause the reflection of seismic waves).

At that point a three-dimensional volume is ready for a geoscience team to start their seismic interpretation. Seismic interpretation can be broadly subdivided into two components: structural interpretation, which investigates the nature and geometry of the subsurface structures; and stratigraphic interpretation, which investigates the subsurface stratigraphy. A major component of structural interpretation is the identification, location, and extraction of individual fault surfaces. Fault surfaces are very important in hydrocarbon exploration because they are directly related to hydrocarbon accumulation and to hydrocarbon flow paths. Extraction of individual fault surfaces from seismic data is a largely qualitative procedure and has thus been characterized by the need for careful human data interpretation. Thus, geoscientists have long awaited automated processes for geologic feature extraction.

In recent years, there has been progress in visualizing stratigraphic and structural discontinuties with the so-called coherence or variance methods, which look at similarity or dissimilarity of a small number of neighboring traces to determine these discontinuities. Some examples of these coherence- and variance-based visualization techniques include U.S. Pat. No. 5,892,732 (GERSZTENKORN) Apr. 06, 1999, US RE38229 E (MARFURT ET AL.) 19.08.2003, U.S. Pat. No. 5,563,949 (BAHORICH ET AL.) Dec. 14, 1994 U.S. Pat. No. 5,740,036 (AHUJA ET AL.) Sep. 15, 1995, U.S. Pat. No. 6,151,155 (DURFEE ET AL.) Jul. 29, 1998, and U.S. Pat. No. 6,138,075 (YOST) Aug. 05, 1998. These existing technologies, however, have a limited precision, and are incapable of isolating fine details, such as fault surfaces or sedimentary layer interfaces that may be only one pixel wide.

Hence, there is a need in the art for an improved method of seismic data processing that allows feature extraction to be performed at a higher level of detail than is possible in existing methods. The present invention provides a solution to this and other problems, and offers other advantages over previous solutions.

### SUMMARY OF THE INVENTION

A preferred embodiment of the present invention provides a method and apparatus for extracting, separating, and labeling geologic features (such as fault surfaces) in seismic data, which is of significant benefit in the art of hydrocarbon exploration. The method includes steps of: a) reading a three dimensional seismic data volume; b) computing the three-dimensional orientation of the subsurface; c) subdividing the original volume into small data volumes that are rotated at a predetermined set of dips and azimuths related to those of the subsurface orientation; d) computing a 3-D edge detection measure on the small volumes formed in step c; e) performing a 3-D contrast enhancement operation in each of the small volumes; f) filtering the result of the contrast enhancement with selected 3-D filters at the predetermined set of dips and azimuths; g) skeletonizing the results of the filtering operation; h) separating the individual fault surfaces, and i) labelling the individual fault surfaces for further interpretation and exploration. The ultimate result obtained by a preferred embodiment of the present invention provides a visual and semantic representation of a set of well-defined, cleanly separated, one-pixel-thick labelled fault surfaces, which is readily usable for seismic interpretation.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating a process of reflection seismography;

FIG. 2 is a diagram depicting a marine seismographic survey vessel in operation in accordance with a preferred embodiment of the present invention;

FIG. 3 is a flowchart representation of an overall process of processing seismic data in accordance with a preferred embodiment of the present invention;

FIG. 4 and FIG. 5 together make up a flowchart representation of a process of skeletonizing features in edge-detected and filtered seismic data in accordance with a preferred embodiment of the present invention;

FIG. 6 is a flowchart representation of an alternative process of skeletonizing features in edge-detected and filter seismic data that may be employed in a preferred embodiment of the present invention;

FIG. 7 is a diagram depicting the relationship between currently examined value and its neighboring data values in the skeletonization process described in and;

FIG. 8 is a flowchart representation of a process of computing a local orientation of skeletonized feature data in accordance with a preferred embodiment of the present invention; and

FIG. 9 is a flowchart representation of a process of identifying and labeling distinct fault surfaces in accordance with a preferred embodiment of the present invention.

### DETAILED DESCRIPTION OF PREFERRED EMBODIMENT(S)

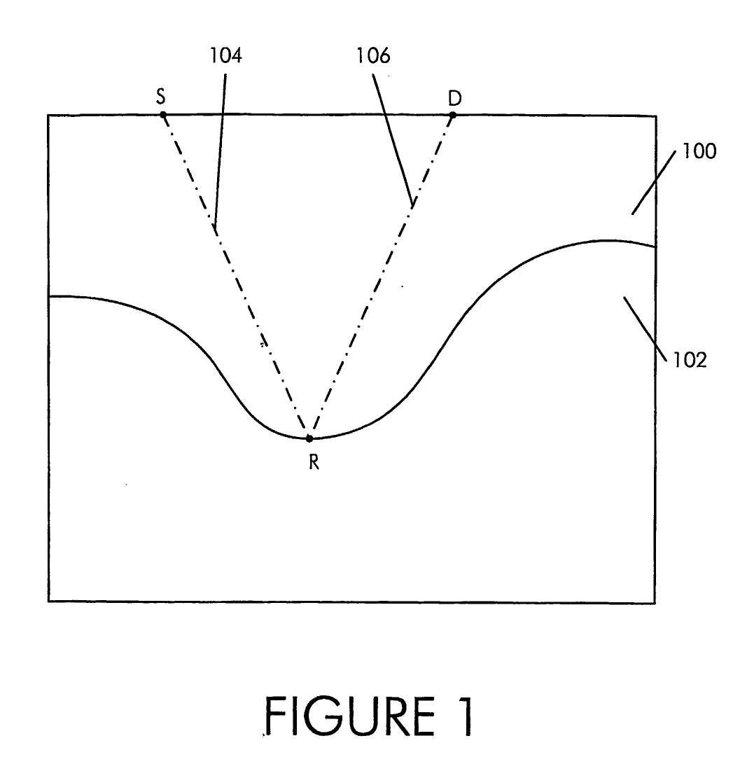

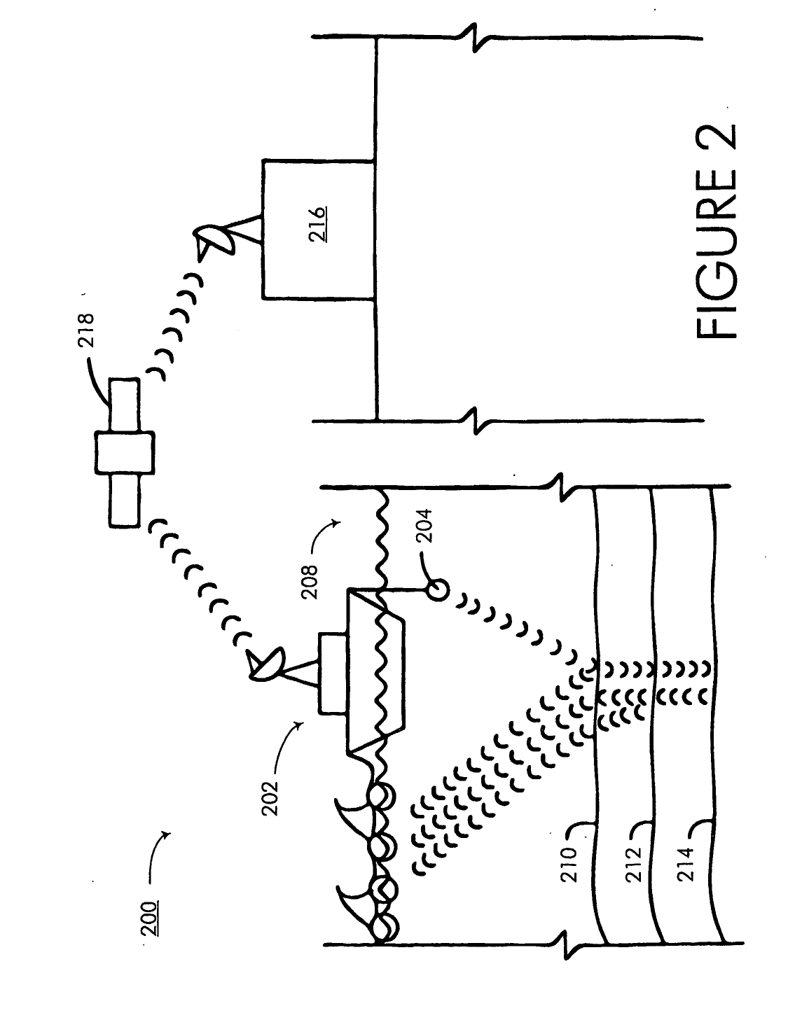

Referring now to the drawings, FIG. 1 provides a schematic representation of an oceanic seismic survey system 100 of the type used to obtain seismic data which can be processed in accordance with preferred embodiments of the present invention. The system 100 includes the use of a seismic vessel 102 having an acoustic wave source 104 and a towed array of spaced-apart receivers 106. For example, the towed array can comprise a total of four to eight streamer cables which are towed in parallel behind the vessel 102, with each cable having a large number (such as 240) of the floatable receivers 106 which are serially attached to the cable.

During operation, the vessel 102 transverses the surface of an ocean 108 in a regular pattern while periodically directing acoustic wave energy (referred to as “shots”) downwardly from the source 104. The wave energy is reflected back to the receivers 106 at an ocean floor boundary 110, as well as at subterranean boundaries (such as 112, 114). The signals detected by the receivers 106 are converted to digital form and stored in computerized data storage equipment (not shown) aboard the vessel 102. It is common to subsequently transmit the resulting data sets to a land-based processing center 116 using a suitable system, such as a satellite communication system 118.

The seismic data sets can be manipulated to produce three dimensional representations (images) of the resulting subterranean features, enabling decisions with regard to the desirability of further exploring a given location for oil and gas deposits. Because the seismic data are arranged in two spatial dimensions and one time dimension, as well as on a per shot basis, seismic data sets can quickly reach several tens of terabytes (10¹² bytes) in size. Thus, to allow near real-time reporting of the seismic data sets to the processing center 116 (while the vessel 102 is still on location), the data are typically compressed and a compressed data set are transmitted via the satellite communication system 118. At this point it will be noted that present invention can be utilized in other environments as well, such as in an onshore exploration setting. Hence, the discussion of the environment of FIG. 1 has been provided merely for purposes of illustration, and is not limiting.

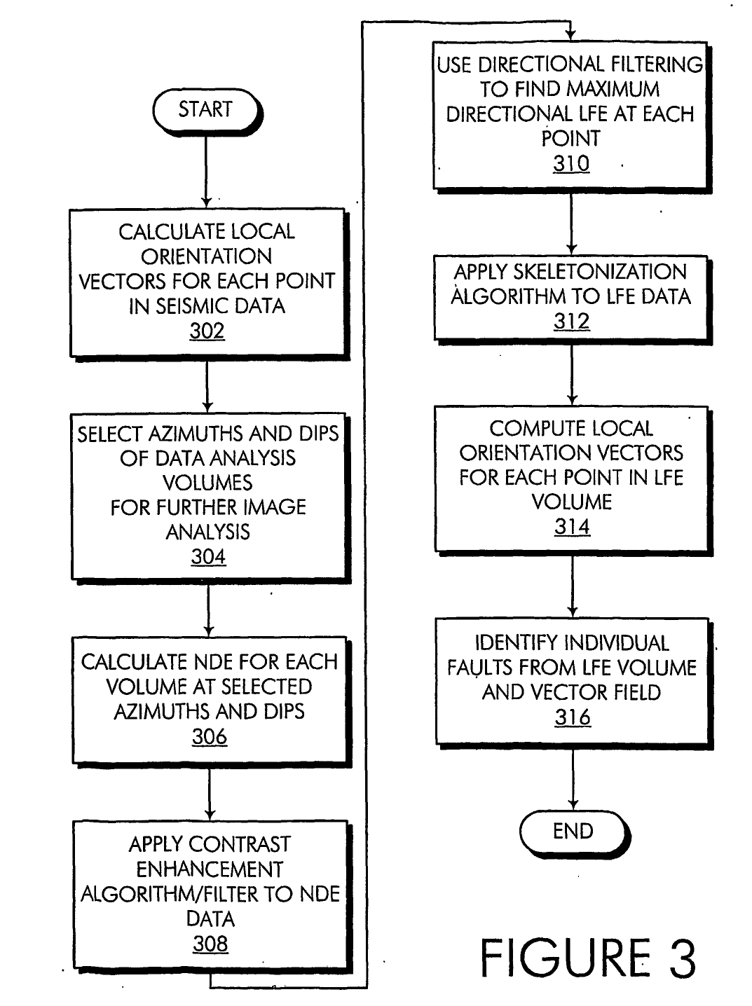

A preferred embodiment of the present invention provides a method and apparatus for extracting, separating, and labeling geologic features (such as fault surfaces) in seismic data, which is of significant benefit in the art of hydrocarbon exploration. Turning now to the flowchart representation provided in FIG. 3, a method for seismic data processing and analysis in accordance with a preferred embodiment of the present invention is now described. The method includes steps of: a) reading a three dimensional seismic data volume; b) computing the three-dimensional orientation of the subsurface (block 604); c) subdividing the original volume into small data volumes that are rotated at a predetermined set of dips and azimuths related to those of the subsurface orientation (block 606); d) computing a 3-D edge detection measure (normalized differential entropy or NDE) on the small volumes formed in step c (block 606); e) performing a 3-D contrast enhancement operation in each of the small volumes (block 608); f) filtering the result of the contrast enhancement with selected 3-D filters at the predetermined set of dips and azimuths to find the maximum directional local fault extraction (LFE) at each point (block 610); g) skeletonizing the results of the filtering operation (block 312); h) computing local orientation vectors for each point in the LFE volume and i) separating the individual fault surfaces and labelling the individual fault surfaces for further interpretation and exploration. The ultimate result obtained by a preferred embodiment of the present invention provides a visual and semantic representation of a set of well-defined, cleanly separated, one-pixel-thick labelled fault surfaces, which is readily usable for seismic interpretation.

In one embodiment of the invention, the steps of the invention are executed in accordance with instructions encoded in computer software by a data processing system that reads three-dimensional seismic volumes and performs the fault surface extraction and labelling and generates a volume with only the extracted individual fault surfaces. This resulting volume can be readily overlaid on an existing seismic interpretation and provides very high resolution detail of small seismic faults, such as synthetic faults, which is virtually impossible to distinguish either manually or with any other computational techniques. Numerous additional advantages of the invention will become evident from the detailed description, the claims, the drawings and the embodiments included.

The local orientation within the three-dimensional seismic volume is computed first. The local orientation computation (with respect to a 2-D seismic volume) involves perfoming the following computational steps (which are also described in RAO, A. R., et al. Computerized flow fields analysis: Oriented texture fields. IEEE Transactions on Pattern Analysis and Machine Intelligence. Jul. 1992, vol. 14, no. 7, p. 693-709.): first smooth the 2-D volume with a local 2-D Gaussian filter; second compute the gradient of the smoothed image; third compute the mean local orientation over a small analysis volume; and finally compute a statistical uncertainty measure called coherence. Assuming a volume with a 2-D gradient value at the point (i,j) equal to G_{i,j,} e^{iφjk} (in Fourier coordinates) then the local orientation estimate is given by the equation:

$${ϕ}_{mn} = \frac{1}{2} {tan}^{- 1} ( \frac{{\sum }_{i = m - N / 2}^{m + N / 2} {\sum }_{j = n - N / 2}^{n + N / 2} {G}_{ij}^{2} sin 2 {θ}_{ij}}{{\sum }_{i = m - N / 2}^{m + N / 2} {\sum }_{j = n - N / 2}^{n + N / 2} {G}_{ij}^{2} cos 2 {θ}_{ij}} )$$

The statistical uncertainty of the local orientation estimate within a local window W is given by the coherence measure:

$$ρ = \frac{{G}_{mn} {\sum }_{( i , j ) ∈ W} ‖ {G}_{ij} cos ( {θ}_{ij} - {θ}_{m} ) ‖}{{\sum }_{( i , j ) ∈ W} {G}_{ij}}$$

With respect to a three dimensional volume, the local orientation is computed in the same way, with the difference that instead of one local orientation there are actually two orientations, as, for example, we use dip and azimuth for 3-D seismic data. Thus, the orientation is computed first in a vertical plane to obtain a value for the dip, then next in a horizontal plane to obtain a value for the azimuth. Thus, while the following discussion involves calculating orientations of 2-D volumes, one of ordinary skill in the art will recognize that the techniques described here may be easily applied in the 3-D context by simply finding separate dip and azimuth orientations through separate 2-D computations in vertical and horizontal directions. Also, one of ordinary skill in the art will also recognize that a high value of the statistical uncertainty measure implies the presence of a fault surface. In existing coherence based methods, such as is described in the aforementioned reference US RE38229 E (MARFURT ET AL.) Aug. 19, 2003, this coherence measure is used directly as an indicator of the presence of a fault surface. In a preferred embodiment of the present invention, however, fault surfaces are identified using edge detection and skeletonization techniques, instead, as will be demonstrated below.

At this point, it is worth mentioning that there are also two other ways to estimate the local orientation of the 3-D seismic volume. The first type of estimate (after BIGUN, J., et al. Multidimensional orientation estimation with applications to texture analysis and optical flow. IEEE Transactions on Pattern Analysis and Machine Intelligence. Aug. 1991, vol. 13, no. 8, p. 775-790.) is as follows: First convolve locally the 3-D volume gradient with a local Gaussian function. Next, transform the seismic data so as to map the data from a Cartesian coordinate system into the complex z-plane (e.g., by mapping coordinates of the form (x,y) into complex numbers of the form x+iy). Then, compute the local orientation as the argument of the local convolution of the local volume gradient (∇f) with a 3-D Gaussian filter (m) as follows
2φ₀=arg((∇f)^{2*m)}

The statistical uncertainty measure of the local orientation is then given by:

$$ρ = \frac{\vert {( ▽ f )}^{2} * m \vert}{{\vert ▽ f \vert}^{2} * m}$$

It turns out that both the local orientation estimate and its uncertainty measure are by-products of the eigenvalues and eigenvectors of the scatter matrix of the local spectrum, which is this case is implemented in the first step outlined above. In fact, another expression for the local orientation estimate is given in terms of the eigenvalues λ₀, λ₁, λ₂ by the following expression

$$ρ = \frac{{λ}_{1} - {λ}_{0}}{{λ}_{0} + {λ}_{1}} .$$

The third way to estimate the local orientation of the 2-D seismic volume is to perform a transform similar to a brushlet transform (MEYER, Francois, et al. Brushlets: A Tool for Directional Image Analysis and Image Compressions. Applied and Computational Harmonic Analysis. 1997, vol. 4, no. 2, p. 147-187.). In this transform, a 2-D Fourier transform is applied to the whole 2-D seismic volume. The 2-D spectrum is then subdivided smoothly as to generate consecutive polar regions corresponding to a contiguous range of orientations. For instance assuming an orientation range of 45 degrees, the 2-D spectrum is subdivided in four polar regions. Neighboring polar regions are connected through smooth bells similar to the ones employed in the design of local trigonometric transforms (see, for example, COIFMAN, Ronald, et al. Orthonormal Wave Packet Basis. Yale University Technical Report Preprint. 1989.). For each of these polar regions, by zeroing out the values outside the regions using appropriate smooth bells and performing an inverse 2-D fast Fourier transform (FFT), the component of the seismic data with local orientation in the range of orientations of the spectral polar region is determined. For example, if the polar region with polar angle of 0-45 degrees was inverted, then the component of the seismic data with local orientation between 0-45 degrees is determined.

The next computational step in the disclosed invention involves subdividing the original three-dimensional seismic volume into a number of individual 3-D data analysis volumes of M×N×P dimension. One possible analysis volume is 41 values by 11 values by six values (41×11×6). The analysis volume is defined by the length along a major axis L₁, the length along a minor axis 2L₂+1 (typically the horizontal axis), time duration of N samples, azimuth φ (rotation angle around the in-line axis), and tilt γ(tilt from the vertical axis).

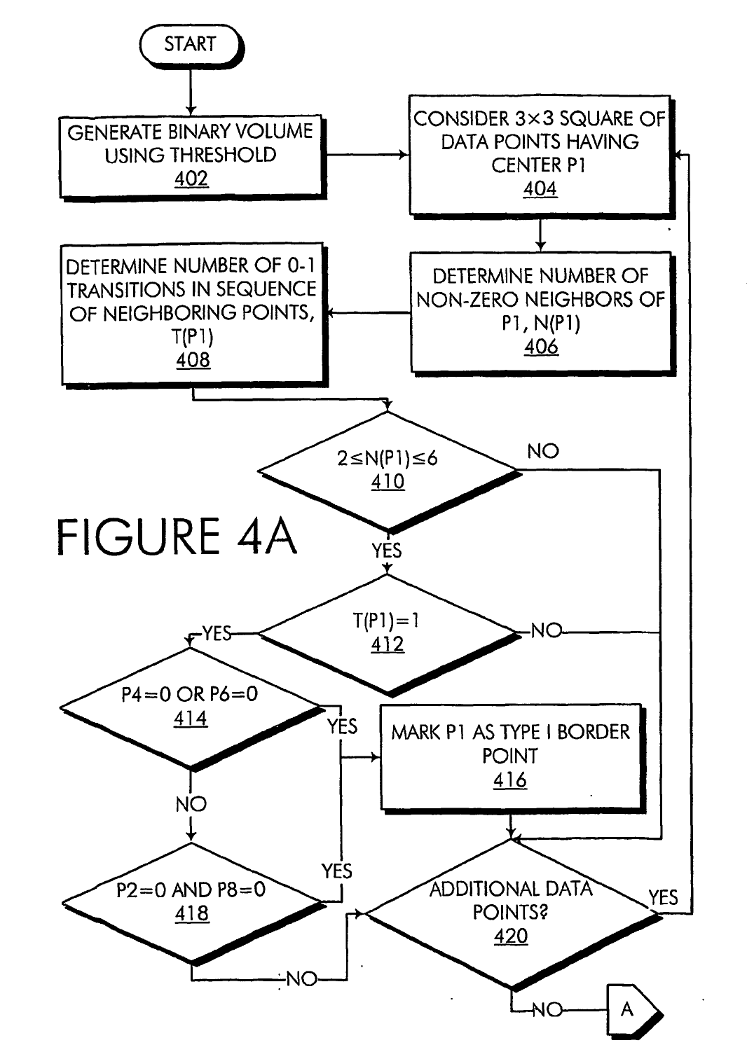

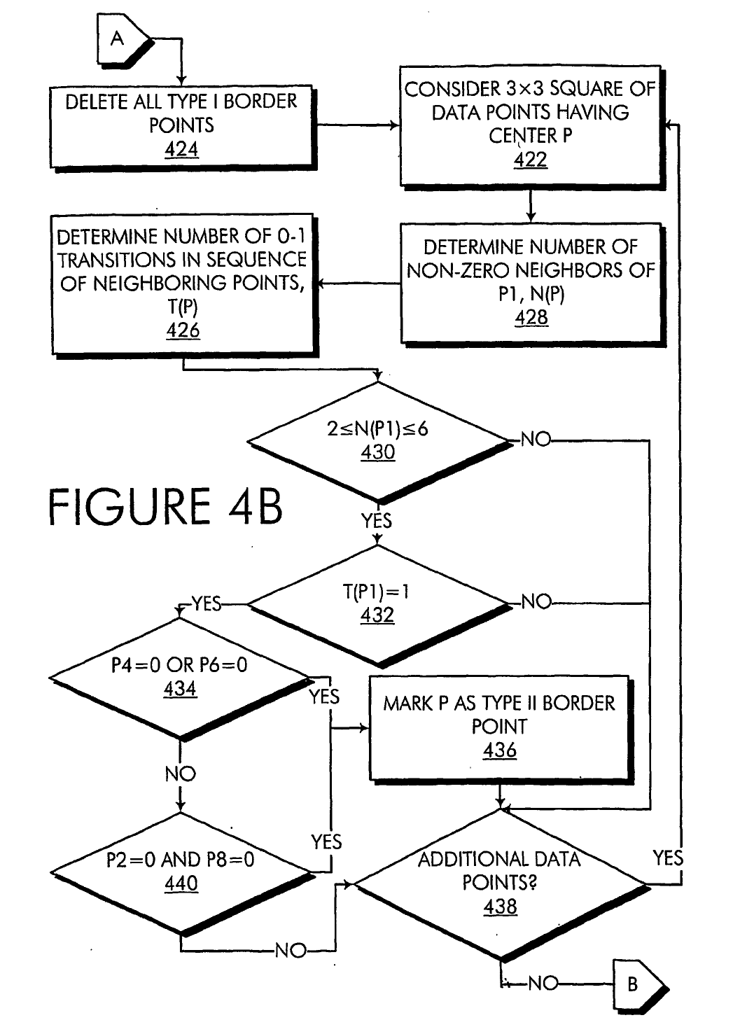

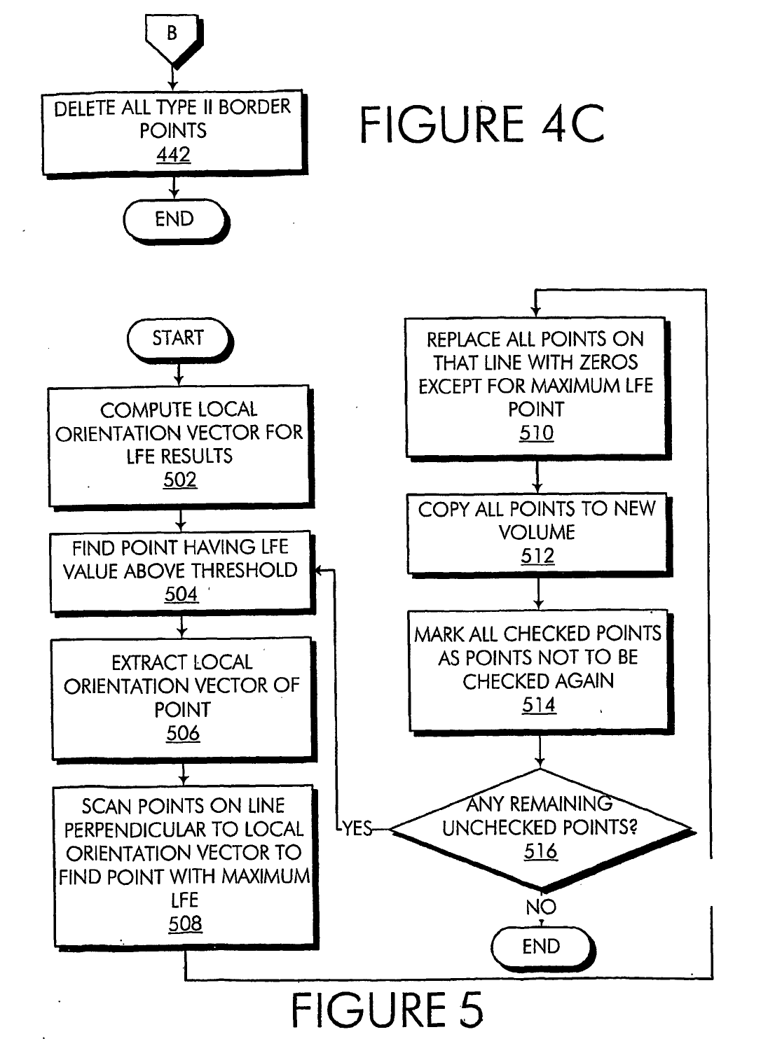

The analysis volume is broken into two subvolumes (for instance for a 41×11×6 analysis cube, each of the two subvolumes is 41×11×3 for a total of 1,353 values) which are rotated and tilted about a central analysis point λ=(x, y, t). In the third dimension the time t or depth d are interchangeable. The samples within the respective subvolumes are rearranged in a consistent manner into two column vectors v_{1,λ}(γ,φ) and V_{2,l}(g,f) as can be seen in FIG. 4. The subvolumes seen in FIG. 4 have horizontal top and bottom surfaces. This is in particular preferrable when the subsurface layers are horizontal or close to horizontal. However, we also have the choice to have the horizontal top and bottom surfaces parallel to the dominant local seismic orientation within the analysis cube as seen in FIG. 5. By rearranging the seismic data within the analysis cube in such a way, the resulting column vectors can be directly used for edge detection. In other words, the fault surface edges defined by a combination of different position of the central analysis point I, the analysis cube size, the rotation f and the tilt g are computed from the pairs of the corresponding two column vectors. The computational method used to compute the seismic edges is a normalized version of the Prewitt filter, as it is explained in JAIN, Anil. Fundamentals of Digital Image Processing. Englewood Cliffs, N.J.: Prentice Hall, 1989. ISBN 0133361659. p. 347, 351. The original paper by Prewitt was published in Picture Processing and Psychopictorics. Edited by LIPKIN Bernice, et al. New York: Academic Press, 1970. ISBN 0124515509. The computations done by this normalized version of the Prewitt filter are designed to capture the edges and breaks visible or invisible, generated by subterranean faults in the seismic data.

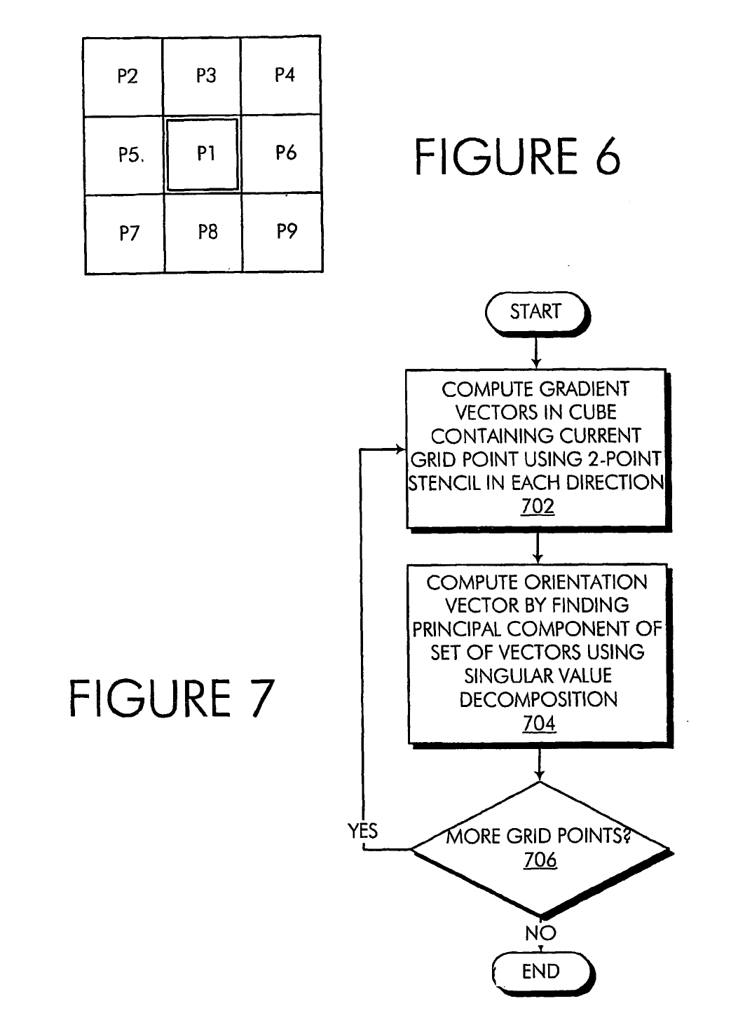

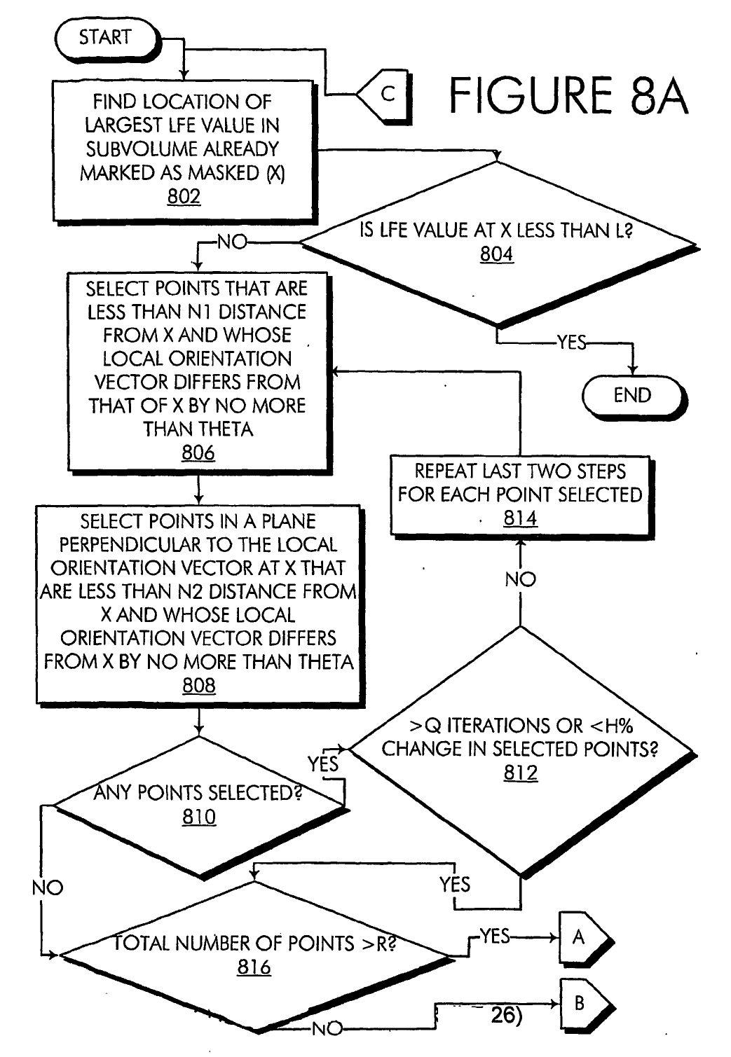

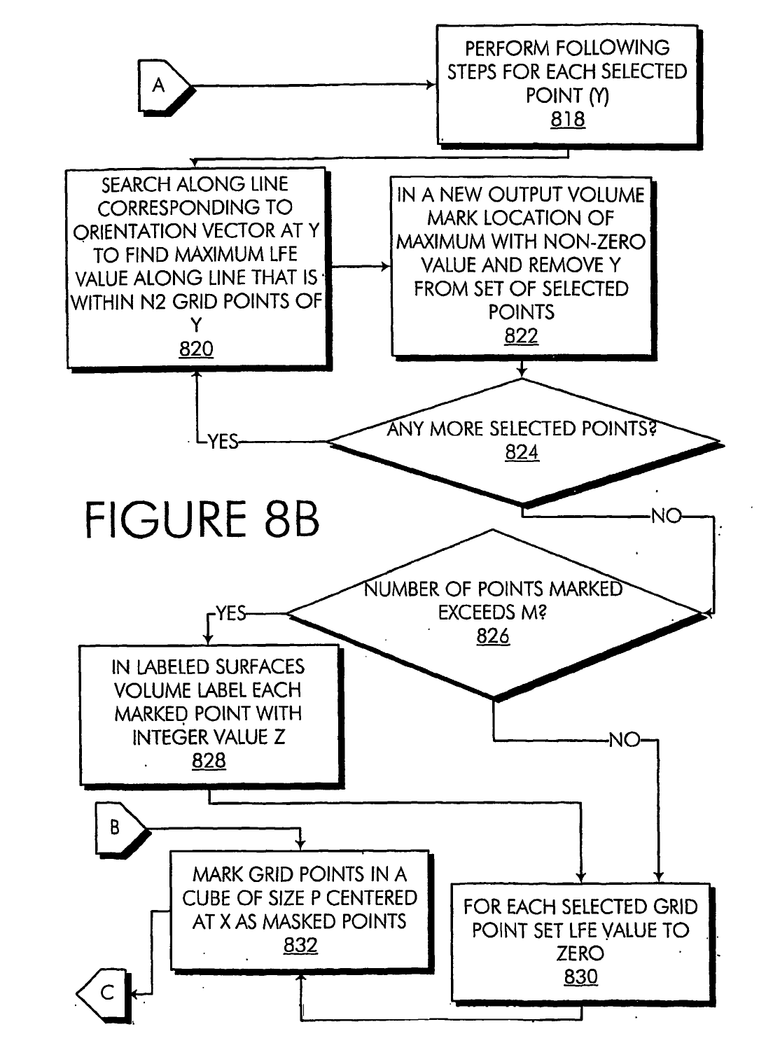

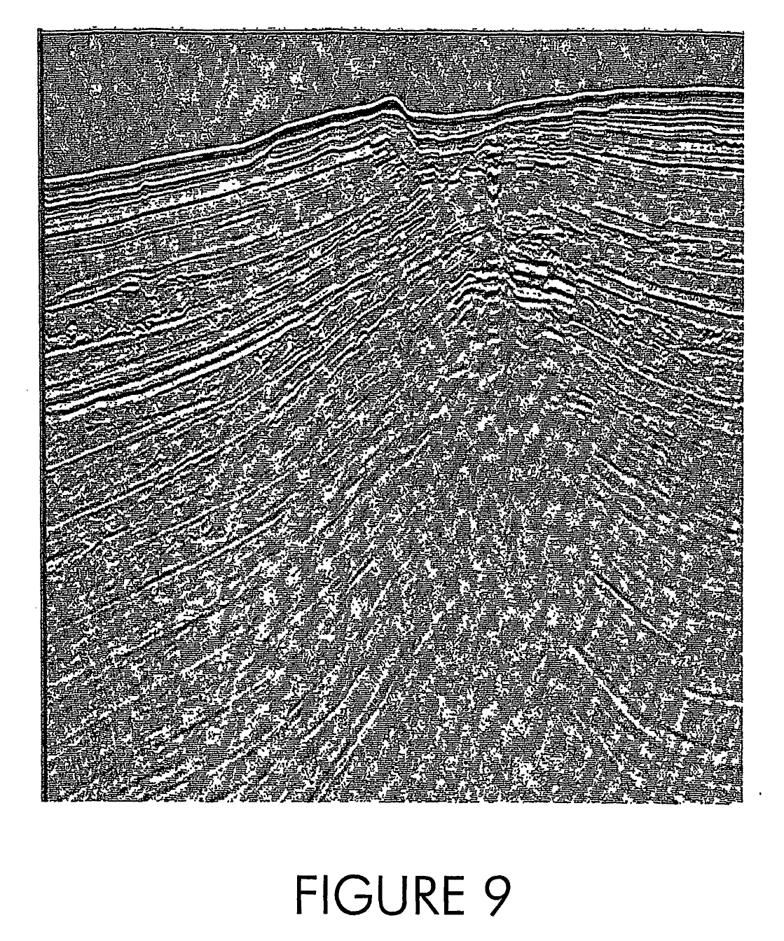

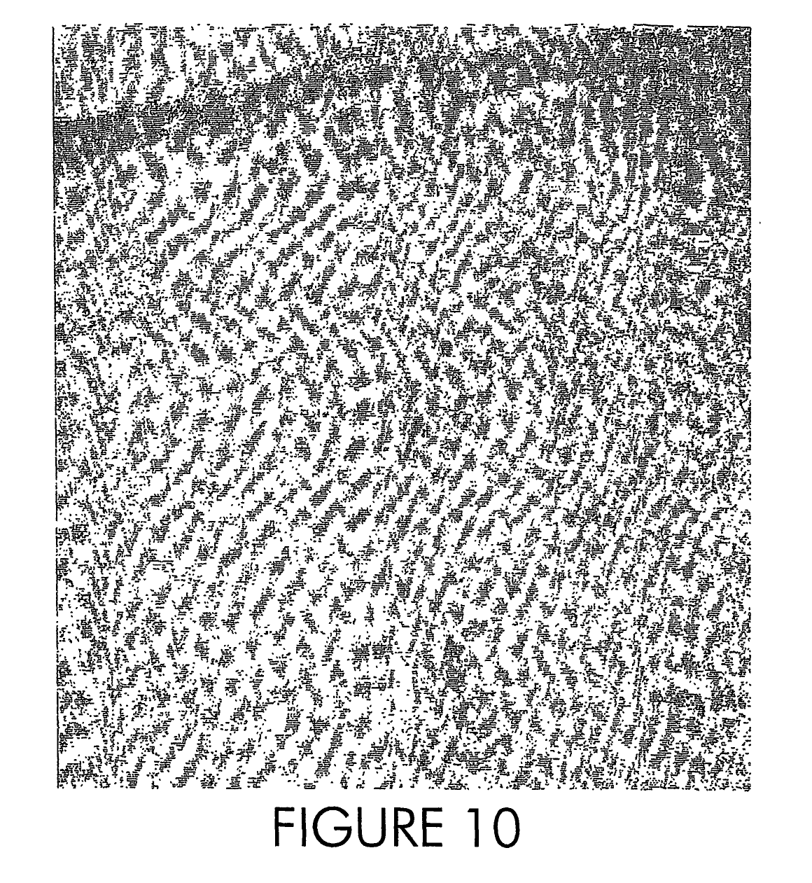

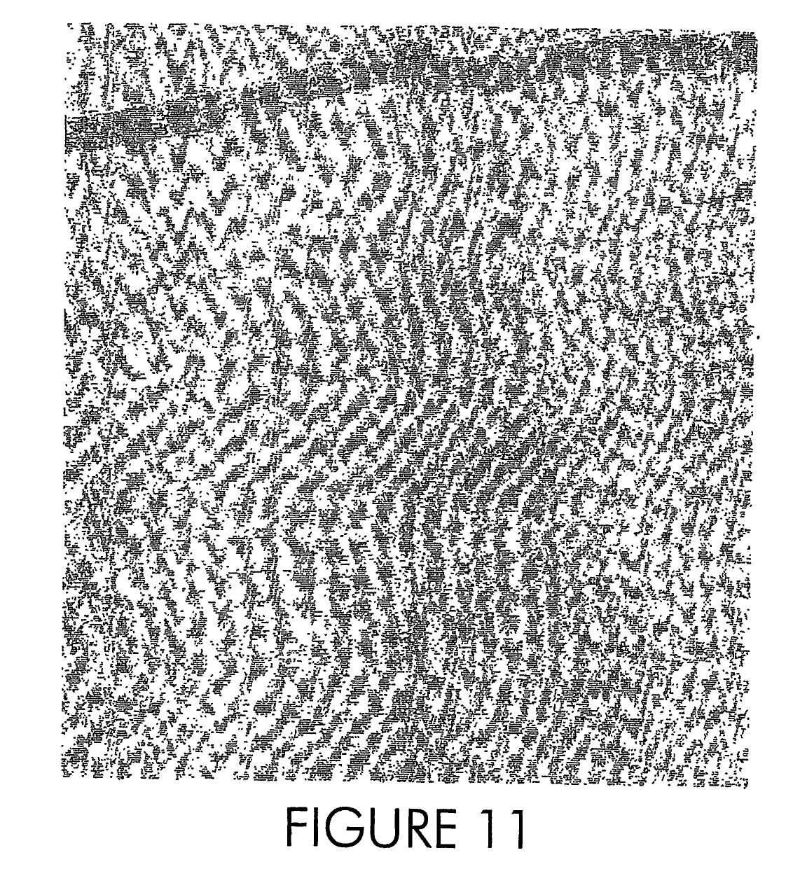

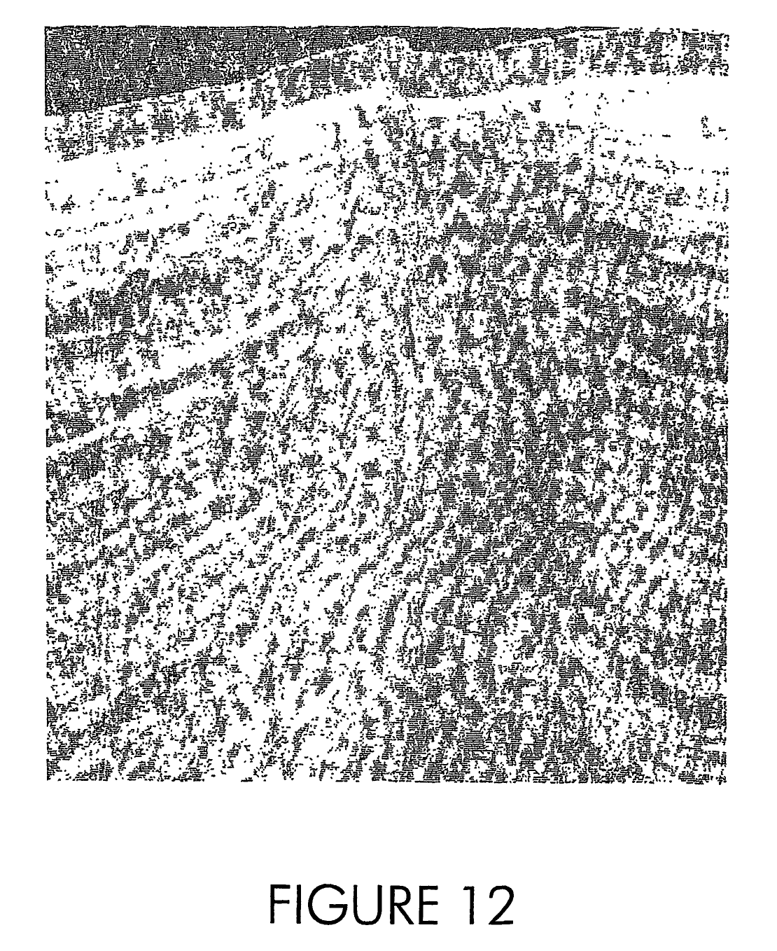

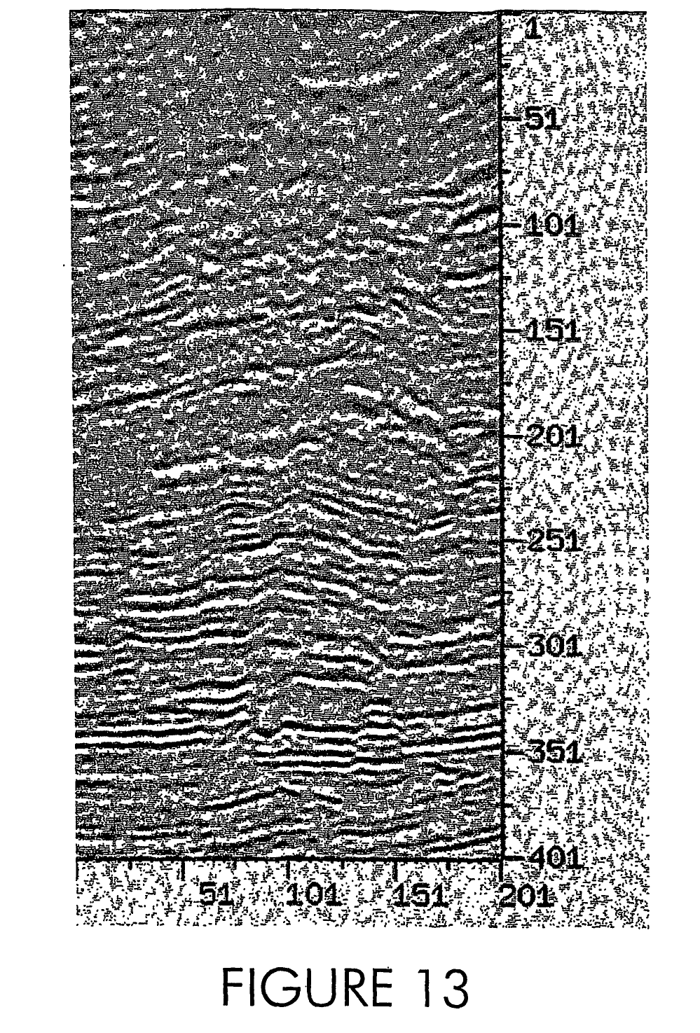

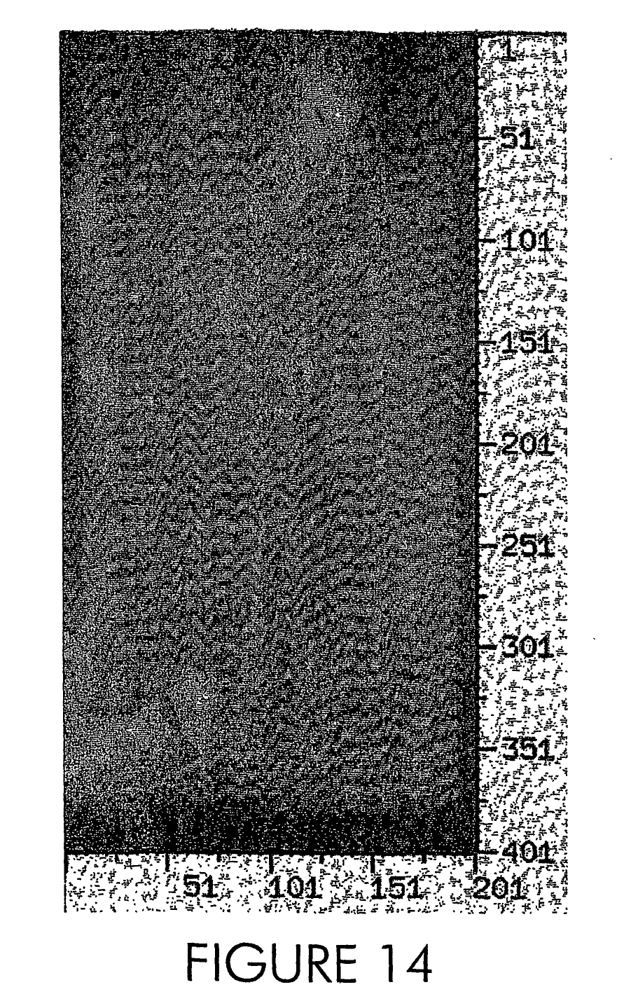

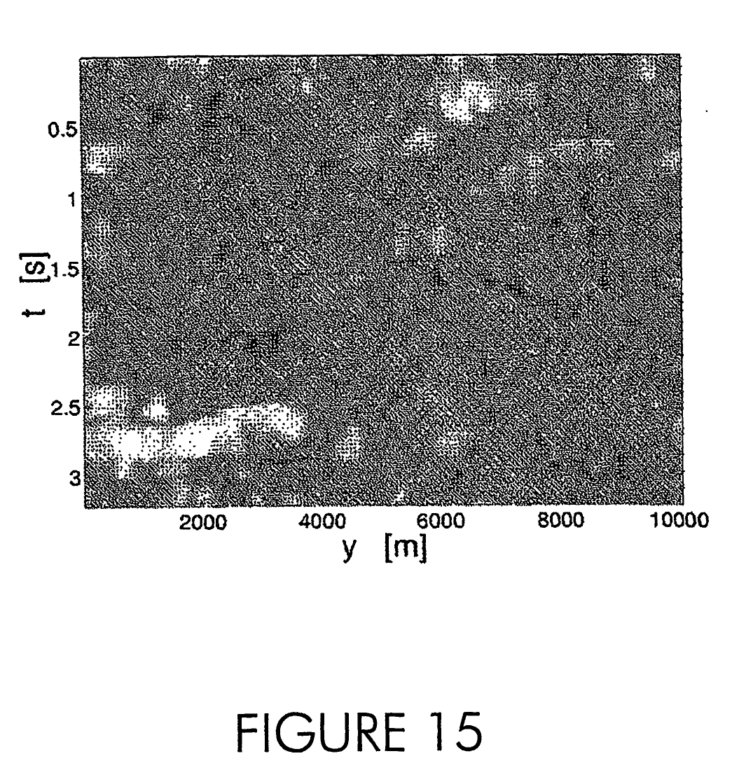

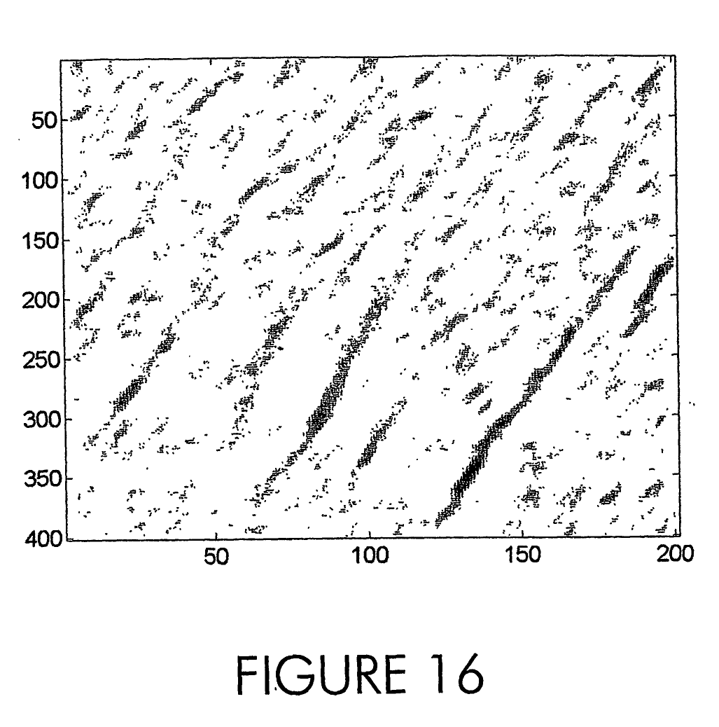

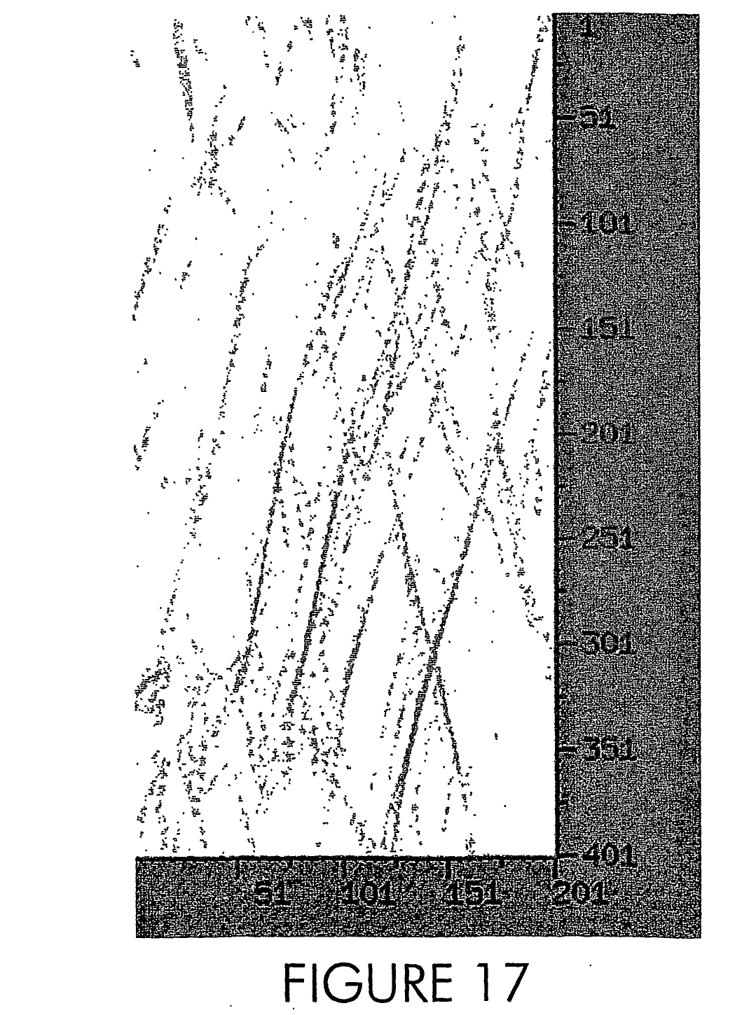

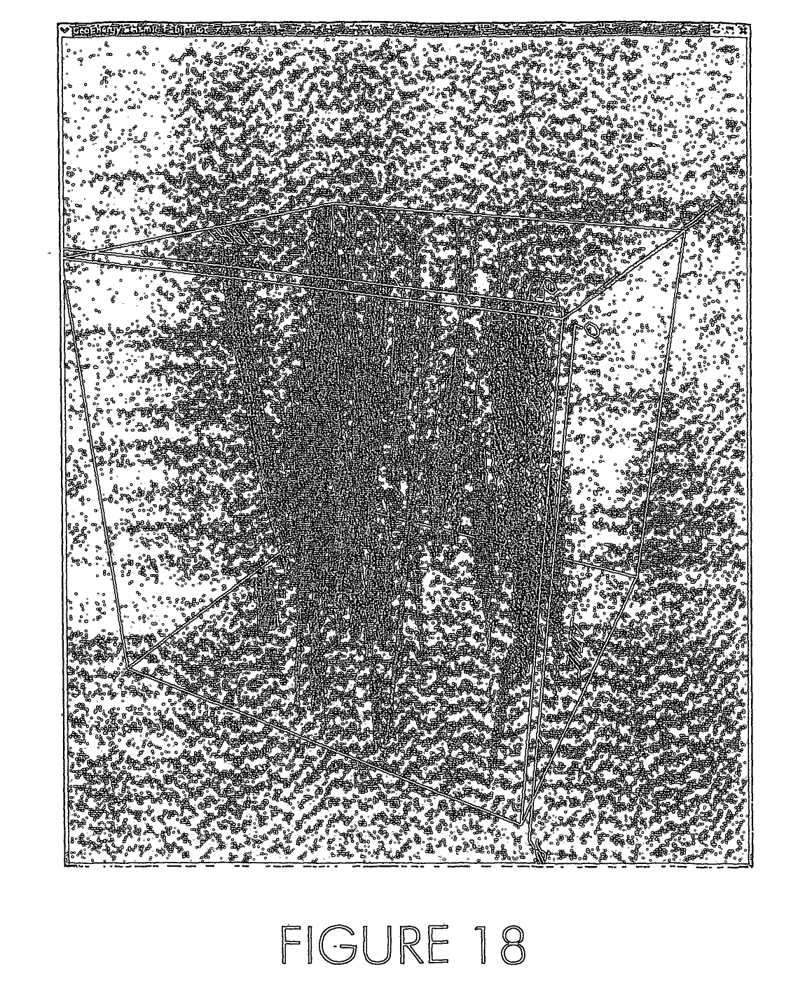

A measure referred to as normalized differential entropy (NDE), or Nₗ(g,f) is computed as a normalized version of the Prewitt filter

$$\frac{{‖ {v}_{1 , λ} ( γ , ϕ ) - {v}_{2 , λ} ( γ , ϕ ) ‖}_{p}}{{‖ {v}_{1 , λ} ( γ , ϕ ) ‖}_{p} + {‖ {v}_{2 , λ} ( γ , ϕ ) ‖}_{p}} .$$

where Nₗ(g,f) is the normalized differential entropy. It is very interesting to observe several things about the 3-D edge detection measure quantified by the normalized differential entropy. First, if the subsurface layers have orientation mostly horizontal with no significant lateral elastic impedance contrasts then we have a NDE measure which produces an excellent edge detector and indicator of the fault surfaces and at the same time a very poor indicator of the subsurface layer interfaces. Second, even when the dominant layer orientation is not horizontal by using top and bottom analysis cube surfaces parallel to the dominant local 3-D seismic orientation, we still obtain a very good 3-D edge detector and indicator of the fault surfaces and at the same time a very poor indicator of the subsurface layer interfaces. Third, the data structure employed for the NDE and its 3-D edge detection computational architecture is completely different than the data structures and the computational setup in the 3-D seismic coherence and variance methods (U.S. Pat. No. 5,930,730 (MARFURT ET AL.) Jul. 27, 1999, U.S. Pat. No. 5,563,949 (BAHORICH ET AL.) Dec. 14, 1994 U.S. Pat. No. 5,740,036 (AHUJA ET AL.) Sep. 15, 1995, U.S. Pat. No. 5,892,732 (GERSZTENKORN) Apr. 06, 1999, U.S. Pat. No. 5,892,732 (GERSZTENKORN) Apr. 06, 1999). Fourth, the result of the NDE and the seismic coherence are completely different in particular when the top and bottom analysis cube surfaces are parallel to the dominant 3-D seismic data orientation. Fifth, even if the top and bottom analysis cube surfaces are horizontal the results of the NDE and the results of the seismic coherency cross-correlation and eigenstructure methods are completely different as evident in FIG. 6 showing an original migrated line, FIG. 7 showing its NDE result, FIG. 8 showing the seismic coherency cross-correlation result and FIG. 9 showing the seismic coherency eigenstructure result. Sixth, when the top and bottom analysis cube surfaces are horizontal there is a very significant overlapping of the analysis cubes for any dip and azimuth combination and further than that there are a lot of common difference computations which are repeatable as it is evidenced by equation (6). All of the possible differences for the NDE computations are computed upfront for all the combinations of the dip and azimuth used, which yields significant acceleration in the NDE computations. We have found from practical experience that a set of 12 dips from −35 to 35 degrees with a 5 degree increment excluding the dips of −5, 0, 5 degrees and 8 azimuths (0, 45, 90, 26, 67, 116, 156) for a 41×6×7 NDE analysis cube is sufficient. By using the upfront NDE local difference computations for all the combinations of dip and azimuth we obtain a computational speedup of about a factor of 20, which is extremely important for efficient computation and extraction of the fault surfaces.

The next step of the disclosed invention involves 3-D contrast enhancement. Fault surfaces having azimuths and dips equal to the azimuth and dips of the analysis volume are distinguished by higher NDE values compared to the local average NDE values. This contrast enhancement facilitates the analysis of regions that contain dipping layers or are highly discontinuous.

The contrast enhancement can be efficiently implemented using a discrete “Mexican Hat” function:
f(n)=C(1−n²)e⁻ⁿ^{²}^{/2}
where C is a normalization constant such that the sum of all the absolute values of the Mexican hat is 2. A finite length filter (−4.5<n<4.5) is used. This contrast enhancement filter contains odd number of uniformly spaced coefficients. Good contrast enhancement results are obtained when using 31 filter coefficients, but in general the selected filter length depends on the size of the analysis cube and the “thickness” of the fault surfaces. The filtered NDE by the Mexican hat function is computed as

$${\overline{N}}_{λ} ( γ , ϕ ) = {g}_{λ} ( γ , ϕ ) * {N}_{λ} ( γ , ϕ ) = {\sum }_{{λ}^{′}} {g}_{λ - {λ}^{′}} ( γ , ϕ ) {N}_{{λ}^{′}} ( γ , ϕ ) \qquad ( 8 )$$

where gl(g,f) is a rotated version of f, such that its main axis is perpendicular to the slabs of the analysis cube. The contrast enhanced NDE volume is provided by
\hat{N}_{λ}(γ,φ)=max{\overline{N}_{λ}(γ,φ),0}

FIG. 10 shows the results of the contrast enhancement applied to the stacked migrated line shown on FIG. 6.

The third step of the Fault Mapping System utilizes 3-D directional filtering, which extracts the portions of fault surfaces that are approximately aligned with the analysis cube.

The directional filter, denoted by hₗ(g+a,f), is a 3-D ellipsoid, tilted by g+a with respect to the time axis, rotated by f with respect to the in-line axis, and normalized by
Σₗhₗ(g,t)=1. The interpreter selects the filter dimensions, which control the minimal dimensions of the detected subsurfaces. The maximum value of a is determined by the increment D_{g}(|a|<D_{g}/2). The implementation uses a 3-D pencil-like shaped Hanning window. A possible set of dimension values for this 3-D pencil-like window are 61 samples at its major axis and 3 samples at its minor axes. A possible value for the dip increment is D_{g}=50, and a possible value for the relative tilt of the directional filter a is restricted to {-2⁰, 2⁰}. A smaller dip increment could be used and the relative tilt could be discarded; however, the above formulation has been found to be computationally more efficient. Directional filtering of the contrast enhanced NDE yields:

$${C}_{λ} ( γ + α , ϕ ) = {\sum }_{{λ}^{′}} {h}_{λ - {λ}^{′}} ( γ + α , ϕ ) {\hat{N}}_{{λ}^{′}} ( γ , ϕ ) \qquad ( 10 )$$

The resulting coefficients from the application of equation (5) are thresholded by d(0<d<1),

$${\tilde{C}}_{λ} ( γ + α , ϕ ) = \{ \begin{matrix}{C}_{λ} ( γ + α , ϕ ) , & if {C}_{λ} ( γ + α , ϕ ) \geq δ \\ 0 , & otherwise\end{matrix} \qquad ( 11 )$$

and then filtered back to produce the directional LFE (Local Fault Extraction) values, determined by:

$${L}_{λ} ( γ , ϕ ) = {\sum }_{{λ}^{′} , α} {h}_{λ} ( γ + α , ϕ ) {\tilde{C}}_{{λ}^{′}} ( γ + α , ϕ ) \qquad ( 12 )$$

The directional LFE volumes contain significant portions of fault surfaces, characterized by roughly the same dip and azimuth orientations as those of the analysis cube.

The fourth step of the Fault Mapping System involves keeping at each point the maximum directional LFE value, over the tested set of dips and azimuths. Specifically, the LFE attribute at the analysis point I is obtained by:
L_{λ}=max{L_{λ}(γ,φ)} (13)

The LFE volume gathers and connects the significant portions of fault into smooth large fault surfaces as demonstrated in FIG. 11 which is the result of the 3-D filtering operation on the original stacked line of FIG. 5.

The next computational step involves a skeletonization step, which is very important in both “filtering out” very small faults or fault-like features and for separating the different fault surfaces. Skeletonization algorithms have been in use in image processing for a significant time. This invention discloses a skeletonization algorithm for 3-D data which is particularly designed for the results of the filtering step outlined above. The skeletonization algorithm disclosed performs the following computations on each horizontal slice of the results of the filtering step previously disclosed:
1. Using a data dependent threshold value we generate a binary volume. We use a 3×3 square to decide if the center point of the square P1 should be kept or deleted. Within the 3×3 square, we denote N(P1) the number of non-zero neighbors of P1, T(P1) the number of 0-1 transitions in the ordered sequence P2->P3->P4->P5->P6->P7->P8>P9->P2; then we classify and flag the point P1 as type-I point to be deleted if:
2. 2<=N(P1)<=6
3. T(P1)=1
4. P4=0 or P6=0; or P2=0 and P8=0
5. Delete all type I border points
6. Flag the type II border points. In a similar manner as previously, a point P1 is defined as a type II point if the following conditions are satisfied:
7. 2<=N(P1)<=6
8. T(P1)=1
9. P4=0 or P6=0 or (P2=0 and P8=0)
10. Delete the flagged type II points.

Iterate through border points to be deleted until there are no more border points to be deleted.

The algorithm for “fault separation, skeletonization and labeling” is as follows:

1. Binarize and skeletonize the 3D data:
a. For each horizontal slice ‘t’, a 2D binarization and skeletonization is performed using the “adaptive image binarization” algorithm (described at the end of the document).
b. For each vertical slice ‘x’ perform 2D skeletonization, and stretch the skeletons (as described in the “adaptive image binarization” algorithm)
c. Repeat Step b for vertical slice ‘y’, horizontal slice ‘t’, vertical slice ‘x’, and so on, until there is no change in the result, or reached to a pre-specified limit of iterations. Each iteration further stretches the skeletons, so the fault surfaces become larger.

1. Remove small skeletons (2.5D):
a. For each vertical slice ‘y’ (ToX plane), remove objects whose size is below a certain threshold.
b. Using the newly produced data, repeat step 2(a) of the algorithm for each vertical slice ‘x’ (ToY plane) and again for each horizontal slice ‘t’ (XoY plane).

2. Label the 3D data:
a. For each separate azimuth, extract the data associated with that azimuth and concatenate the extracted data along the fourth dimension, ordered according to the azimuth value, thus producing a 4D data that contains the azimuth information as well. Label the newly produced 4D data and re-create a 3D labeled data by taking the maximum along the fourth dimension. This will create a labeled version of the 3D data, such that objects are distinguished by their azimuths as well, and therefore differently labeled if their azimuths are not close one to another.
b. Identify objects whose size is above a certain threshold, remove all other objects and re-label the remaining objects in an ascending order (if more than 255 objects have been identified, keep only the largest 255 objects).

The algorithm for “adaptive image binarization” is as follows:
1. Define two thresholds—low and high.
   The high threshold should be defined such that low intensity objects will be removed by the high threshold binarization and yet objects that are supposed to be kept in the image will not be completely erased by the high threshold binarization.
   The low threshold should be defined such that connectivity between two close objects will be gained and yet no unnecessary pixels will be marked as ‘1’.
2. Binarize the original image using the high threshold (threshold operation only).
3. Skeletonize the binary image.
4. For each pixel in the skeletonized image that is marked as ‘1’ and has no neighbors marked as ‘1’ or has only one neighbor marked as ‘1’ (edge points) do the following:
   a. For a pixel that has no neighbors marked as ‘1’:
   Find the pixel with the maximum value among the 8-connected neighborhood of the corresponding pixel in the original image.
   For a pixel that has only one neighbor marked as ‘1’:
   Find the pixel with the maximum value among the pixels in the original image that belong to the 8-connected neighborhood of the pixel and are “not too close” to the neighbor pixel marked as ‘1’. The locations of the pixels that are “not too close” to the neighbor pixel marked as ‘1’ are shown in the following figures (the left figure refers to the possibility that the neighbor marked as ‘1’ belongs to the

4-connected neighborhood and the right figure refers to the other possibility):

TABLE 1

| | | |
|---|---|---|
| Neighbor | | |
| Marked | | |
| as ‘1’ | | |
| | Center | X |
| | Pixel | |
| | X | X |

TABLE 2

| | | |
|---|---|---|
| Neighbor | | |
| Marked | | |
| as ‘1’ | | |
| | Center | X |
| | Pixel | |
| | X | X |

b. If this maximum value is above the low threshold, mark the corresponding pixel in the skeletonized image as ‘1’.
Otherwise try to find such a pixel (i.e., one that is above the low threshold) in the 5×5 neighborhood in a similar manner. If such a pixel exists, mark the corresponding pixel in the skeletonized image as ‘1’ and also mark the appropriate pixel in the 3×3 neighborhood so connectivity will be retained.
c. If the newly marked pixel (the outer pixel in the case of 5×5 neighborhood) has only one neighbor marked as ‘1’, go to step 4(a) in the algorithm for the newly marked pixel.
   Remark:
The skeletonized image is updated as necessary at the various steps of the algorithm, and every step in the algorithm uses the previously updated skeletonized image.
   Implementation Details:
The function that implements steps 4(a) through 4(c) in the algorithm can be implemented as a recursive function (and is recursively called as necessary in step 4(c) of the algorithm).

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for seismic exploration, comprising actions of:
(a) obtaining a set of seismic data traces representing a three-dimensional volume of seismic data samples;
(b) dividing the three-dimensional volume into a plurality of smaller subvolumes;
(c) selecting a discrete set of dip values and azimuth values;
(d) dividing the three-dimensional volume into a plurality of parallelepipeds, each of the parallelpipeds being tilted by one of the selected dip values and rotated by one of the selected azimuth values;
(e) halving each parallilepiped to obtain two half-parallelpipeds, wherein the two half-parallelpipeds have contain an equal number of samples and there exists a one-to-one relationship between corresponding samples in the two half-parallelpipeds;
(f) enumerating the samples in each of the two half-parallelpipeds so as to obtain two vectors, such that corresponding samples in the two half-parallelpipeds have corresponding indices in the two vectors;
(g) calculating a three-dimensional edge detection measure from the two vectors;
(h) associating the computed edge detection measure to the parallilepiped center point to obtain a first subresult;
(i) applying a constrast enhancement measure to the first subresult to obtain a second subresult;
(j) filtering the second subresult to obtain a set of third subresults by convolving the second subresult with a directional filter kernel that is tilted and rotated in accordance with a set of dip and azimuth values that correspond to the selected dip values and azimuth values of the computational analysis parallilepiped associated with the second subresult;
(k) selecting a maximum filtered value from the set of third subresults;
(l) applying a three-dimensional skeletonization algorithm to the maximum filtered value to generate a skeleton representing a fault surface;
(m) executing action (l) with respect to the maximum filtered value for each of the plurality of parallelpipeds to obtain a plurality of distinct skeletons; and
(n) labeling each of the plurality of distinct skeletons as a separate geologic feature.

2. The method of claim 1, wherein the method comprises an additional action of:
(b1) computing, for at least one of the subvolumes, a local seismic data orientation and an associated statistical uncertainty, and further, wherein each of the plurality of parallelpipeds is associated with a subvolume from the plurality of subvolumes and each of the plurality of parallelpipeds has a top surface and a bottom surface that are parallel to the local seismic data orientation for the subvolume associated with that parallelpiped.

3. The method of claim 2, where action (b1) further includes:
(b1a) applying a smoothing function to a subvolume;
(b1b) computing, in three dimensions, a local orientation of seismic data within the subvolume;
(b1c) averaging, over a surrounding three-dimensional space, the local orientation of seismic data within the subvolume to obtain a stable orientation estimate; and
(b1d) computing a measure of statistical uncertainty of the orientation estimate.

4. The method of claim 2, where action (b1) further includes:
(b1a) transforming the seismic data of a subvolume so as to map Cartesian coordinates of the subvolume into complex values in a complex plane;
(b1b) computing a three-dimensional gradient of the subvolume;
(b1c) convolving the three-dimensional gradient with a three-dimensional Gaussian filter to obtain a convolution result;
(b1d) extracting a local orientation estimate of the subvolume as the argument (in the sense of a complex number) of the convolution result; and
(b1e) computing an uncertainty measure (ρ) of the local orientation estimate as
$$ρ = \frac{{λ}_{1} - {λ}_{0}}{{λ}_{1} + {λ}_{0}} ,$$
where λ₀ and λ₁ are eigenvalues of a scatter matrix for the subvolume's local spectrum.

5. The method of claim 1, wherein the selected dip values are selected from an interval extending from about −45 degrees to about 45 degrees and with a dip increment selected from an interval extending from about 5 degree to about 10 degrees.

6. The method of claim 1, wherein the selected azimuth values are selected from an interval extending from about 0 degrees to about 180 degrees and wherein the selected azimuth values are selected using an azimuth increment selected from an interval extending from about 5 degrees to about 30 degrees.

7. The method of claim 1, wherein at least one of the parallelpipeds is tilted by a selected dip value and rotated by a selected azimuth angle to form a parallelpiped having integer dimensions of the form L₁×(2L₂+1)×N, with N representing a number of samples measured with respect to a vertical dimension of the parallelpiped, with the selected dip value measured with respect to the vertical direction, and the azimuth measured with respect to a direction of north in the seismic data.

8. The method of claim 7, wherein each parallelpiped has a minimum dimension L₁ of 6, a minimum dimension 2L₂₊₁ of 5 samples and a minimum vertical dimension N of 41 samples.

9. The method of claim 7, wherein the set of selected azimuth values is exclusively dependent on L₁.

10. The method of claim 9, where the set of selected azimuth values has a cardinality of at least 8.

11. The method of claim 1, wherein the edge detection measure for a given parallelpiped having a central analysis point λ is at least a function of
∥v_{1,λ}(γ,φ)−v_{2,λ}(γ,φ)∥ₚ
and
∥v_{1,λ}(γ,φ)∥ₚ+∥v_{2,λ}(γ,φ)∥ₚ
where v_{1,λ} and v_{2,λ} are the two vectors generated from halving the parallelpiped, γ and φ are the parallelpiped's dip, and azimuth, respectively, and p denotes a choice of vector space norm for a vector space in which v₁ and v₂ are defined.

12. The method of claim 11, wherein the three dimensional edge detection measure is a function of
$$\frac{{‖ {v}_{1 , λ} ( γ , ϕ ) - {v}_{2 , λ} ( γ , ϕ ) ‖}_{p}}{{‖ {v}_{1 , λ} ( γ , ϕ ) ‖}_{p} + {‖ {v}_{2 , λ} ( γ , ϕ ) ‖}_{p}} .$$

13. The method of claim 12, wherein values of
∥v_{1,λ}(γ,φ)−v_{2,λ}(γ,φ)∥ₚ
and
∥v_{1,λ}(γ,φ)∥ₚ+∥v_{2,λ}(γ,φ)∥ₚ
are computed only once per each pair of vectors v_{1,λ} and v_{2,λ} and dip/azimuth combination, are subsequently stored in memory so as to memoize the computed values such that the computed values need not be recomputed for that pair of vectors and dip/azimuth combination.

14. The method of claim 13, wherein the memoized computed values from a window of preceding edge detection measure computations are utilized, through dynamic programming, to compute subsequent edge detection measures.

15. The method of claim 1, wherein the contrast enhancement measure is a function of a filter that is applied by convolving the first subresult with a rotated form of a “Mexican hat function” of the form
f(n)=C(1−n²)e⁻ⁿ^{²}^{/2},
(where e is the base of the natural logarithm function) for values of n taken from an interval extending from about −4.5 to 4.5, the filter containing an odd number of filter coefficients and having its main direction perpendicular to slabs of the first subresult's corresponding parallelpiped, wherein convolving the first subresult with the rotated form of the “Mexican hat function” results in a “Mexican hat function convolution result.”

16. The method of claim 15, wherein the contrast-enhanced three-dimensional edge detection measure is computed as the maximum of the “Mexican hat function convolution result” and zero.

17. The method of claim 1, where portions of fault surfaces that are approximately aligned with a parallelpiped are extracted.

18. The method of claim 17, wherein the directional filter kernel represents a three-dimensional finite impulse response filter having a set of coefficients characterized by a primary axis, a secondary axis, and a tertiary axis, wherein the secondary and tertiary axes are significantly shorter in length than the primary axis.

19. The method of claim 18, wherein the three-dimensional filter is rotated by an angle γ+α with respect to a time axis and rotating it by an angle φ around an in-line axis, wherein α represents a being a tolerance of dip increment.

20. The method of claim 19, wherein the three-dimensional filter has a number of coefficients in the primary direction that is at least equal to a number of samples in a corresponding direction of the parallilepiped.

21. The method of claim 20, wherein the three-dimensional filter is a long three-dimensional Hanning window with very small number of coefficients along the secondary and tertiary axes in relation to the number of coefficients along the primary axis.

22. The method of claim 21, wherein obtaining the set of third subresults includes applying, to a result of the three-dimensional filter, a threshold function defined by a user-determined threshold.

23. The method of claim 22, further comprising filtering the set of third subresults to produce a three-dimensional volume output in which portions of fault surfaces parallel to the selected dip and azimuth values are distinguished.

24. The method of claim 23, further comprising selecting the maximum directionally filtered output value over the filtered set of third subresults.

25. The method of claim 24, wherein the three-dimensional skeletonization algorithm is applied to the maximum directionally filtered output value.

26. The method of claim 24, wherein action (m) further includes actions of:
(m1) computing a local orientation volume for the set of third results, the computation of the local orientation volume being accomplished by computing local gradient vectors at each volume point using a 2-point stencil in each direction and finding a principal component of the local gradient vectors using singular value decomposition;
(m2) finding the location x of a largest-valued point in an output of action (I) that has not already been marked as masked point and ending execution of action(m) if largest-valued point's value is smaller than a threshold fault value;
(m3) selecting points that are less than a predetermined distance of N₁ from x in a horizontal plane containing x, with N₁ and that have a local orientation vector that is within a preselected orientation difference threshold;
(m4) selecting points that lie in a plane perpendicular to the local orientation vector at the point x, that are less than a predetermined distance of N₂ from x, and that have a local orientation vector that is within a preselected orientation difference threshold;
(m5) repeating actions (m3) and (m4), considering one iteration for all of the points selected in actions (m3) and (m4) until the total number of iterations exceeds a preselected number of iterations;
(m6) marking output volume points around points of maximum fault volume value as masked points in response to a determination that a total number of points selected is less than a preselected number of minimum points;
(m7) skeletonizing fault surfaces composed of the selected points from actions (m3) and (m4) in response to a determination that the total number of selected points is greater than a preselected number of points;
(m8) zeroing selected fault output volume points in response to a determination that a number of selected points is smaller than a preselected number of points;
(m9) in response to a determination that a number of points selected during a immediately preceding iteration of skeletonization is greater than a preselected number of points, labelling the skeletonized fault surfaces with labels that are unique to each fault surface.

27. The method of claim 26, wherein skeletonization includes:
selecting a point “γ” in accordance with either action (m3) or action (m4);
searching along a line that passes through γ and is parallel to the local orientation vector and finding a location of a maximum fault output volume along that line that is within N₂ grid points of γ,
marking in a new output volume the location of the maximum fault output volume value with a non-zero value; and
removing γ from the set of points selected in actions (m3) and (m4)

28. The method of claim 25, wherein the skeletonized filtered volume is stored in magnetic media for subsequent use.

29. The method of claim 29, wherein descriptions of individual fault surfaces are stored in magnetic media for subsequent use.

30. An apparatus for processing and analyzing seismic trace data, comprising means for:
(a) obtaining a set of seismic data traces representing a three-dimensional volume of seismic data samples;
(b) dividing the three-dimensional volume into a plurality of smaller subvolumes;
(c) selecting a discrete set of dip values and azimuth values;
(d) dividing the three-dimensional volume into a plurality of parallelipipeds, each of the parallelpipeds being tilted by one of the selected dip values and rotated by one of the selected azimuth values;
(e) halving each parallilepiped to obtain two half-parallelpipeds, wherein the two half-parallelpipeds have contain an equal number of samples and there exists a one-to-one relationship between corresponding samples in the two half-parallelpipeds;
(f) enumerating the samples in each of the two half-parallelpipeds so as to obtain two vectors, such that corresponding samples in the two half-parallelpipeds have corresponding indices in the two vectors;
(g) calculating a three-dimensional edge detection measure from the two vectors;
(h) associating the computed edge detection measure to the parallilepiped center point to obtain a first subresult;
(i) applying a constrast enhancement measure to the first subresult to obtain a second subresult;
(j) filtering the second subresult to obtain a set of third subresults by convolving the second subresult with a directional filter kernel that is tilted and rotated in accordance with a set of dip and azimuth values that correspond to the selected dip values and azimuth values of the computational analysis parallilepiped associated with the second subresult;
(k) selecting a maximum filtered value from the set of third subresults;
(l) applying a three-dimensional skeletonization algorithm to the maximum filtered value to generate a skeleton representing a fault surface;
(m) executing action (I) with respect to the maximum filtered value for each of the plurality of parallelpipeds to obtain a plurality of distinct skeletons; and
(n) labeling each of the plurality of distinct skeletons as a separate geologic feature.
